(19) United States
(12) Patent Application Publication
(10) Pub. No.: US 2006/0019205 A1
(43) Pub. Date: Jan. 26, 2006

(54) Thermographic materials processable at lower temperatures

(75) Inventors: Joe E. Maskasky, Rochester, NY (US); Victor P. Scaccia, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/895,727

(22) Filed: Jul. 21, 2004

(51) Int. Cl. G03C 1/00

(52) U.S. Cl. 430/619

(57) ABSTRACT

Direct thermographic materials can be imaged at lower temperatures. These materials include a non-photosensitive, non-halogen-containing organic silver salt and a reducing agent for silver ions. The materials also contain a halogen-containing compound that has at least 2 carbon atoms and is capable of releasing its halogen to form silver halide when heated to a temperature between 60 and 141° C. in the presence of source of silver.

### FIELD OF THE INVENTION

This invention relates to black-and-white thermographic materials (“direct thermal” materials) that can provide images at relatively lower developing temperatures. This invention also relates to methods of imaging using these thermographic materials.

### BACKGROUND OF THE INVENTION

Silver-containing thermographic imaging materials (“direct thermal” materials) are non-photosensitive materials that are used in a recording process wherein images are generated by the direct application of thermal energy. These materials have been known in the art for many years and generally comprise a support having disposed thereon one or more imaging layers comprising (a) a relatively or completely non-photosensitive source of reducible silver ions, (b) a reducing composition (usually including a developer) for the reducible silver ions, (c) a suitable hydrophilic or hydrophobic binder, (d) image toning agents, and (e) development accelerators. Thermographic materials are sometimes called “direct thermal” materials in the art because they are directly imaged by a source of thermal energy without any transfer of the energy or image from another material.

In a typical thermographic construction, the image-forming layers are based on silver salts of long chain, fatty acids. The preferred non-photosensitive reducible silver source is a silver salt of a long chain aliphatic carboxylic acid having from 10 to 30 carbon atoms, such as behenic acid or mixtures of acids of similar molecular weight. At elevated temperatures, the silver of the silver carboxylate is reduced by a reducing agent whereby a black-and-white image of elemental silver is formed.

Problem to be Solved

U.S. Pat. No. 6,686,133 (Friedel) describes the use of mixtures of non-photosensitive silver salts in photothermographic materials. These mixtures allegedly enable lower processing temperatures.

It is known that photothermographic imaging materials rely on silver metal produced by the exposed light-sensitive silver halide grains (that is, the latent image) that upon heating, causes development of the non-photosensitive silver salts present in close proximity, producing a viewable image of silver metal. However, photosensitive silver halide grains are not used in direct thermographic systems that rely on imagewise heating to form selective darkening through silver salt development. Therefore thermographic materials generally require higher temperatures than photothermographic materials for development. Photosensitive silver halide grains cannot be added to thermographic materials with out adversely affecting the printout in the non-imaged areas.

There is a need for thermographic recording materials that can be processed at relatively lower temperatures to enable a higher imaging throughput to be realized.

### SUMMARY OF THE INVENTION

The present invention provides a non-photosensitive direct thermographic material comprising a support having thereon at least one thermally sensitive imaging layer comprising a binder, and further comprising:
a) a non-photosensitive, non-halogen-containing organic silver salt that is incapable of forming silver halide in imaged areas when heated to a temperature between 60 and 141° C.,
b) a reducing agent for reducible silver ions in the organic silver salt, and
c) a halogen-containing organic compound that has at least 2 carbon atoms and is capable of releasing its halogen to form silver halide when heated to a temperature between 60 and 141° C. in the presence of a source of silver, the thermally releasable halogen being present in an amount of from about 1 to 49 mol % based on total silver in the material.

In some preferred embodiments, this invention provides a black-and-white, non-photosensitive thermographic material that comprises a transparent polymer support having on only one side thereof one or more thermally sensitive imaging layers and an outermost non-thermally sensitive protective layer over the one or more thermally sensitive imaging layers, the material comprising a total amount of silver of from about 0.002 to about 0.03 mol/m², the one or more thermally sensitive imaging layers comprising one or more binders, and in reactive association:
a) a non-photosensitive, non-halogen-containing silver carboxylate salt comprising silver behenate and from about 51 to 99 mol % of total silver in the material,
b) a reducing agent for the non-photosensitive source reducible silver ions comprising a dihydroxybenzene,
c) a toning agent, and
d) an organic silver salt of 2-chlorostearic acid, 2-chloropropionic acid, 2-bromohexadecanoic acid, 6-bromohexadecanoic acid, or 2-iodohippuric acid, and comprising from about 1 to 49 mol % of total silver in the material.

In other preferred embodiments, this invention provides a black-and-white, non-photosensitive thermographic material that comprises a transparent polymer support having on only one side thereof one or more thermally sensitive imaging layers and an outermost non-thermally sensitive protective layer over the one or more thermally sensitive imaging layers, the material comprising a total amount of silver of from about 0.002 to about 0.03 mol/m², the one or more thermally sensitive imaging layers comprising one or more binders, and in reactive association:
a) a non-photosensitive, non-halogen-containing silver carboxylate salt comprising silver behenate and 100 mol % of total silver in the material,
b) a reducing agent for the non-photosensitive source reducible silver ions comprising a dihydroxybenzene,
c) a toning agent, and
d) 2-bromodecane, 1-iodohexadecane, or (2-iodoethyl)benzene that comprises thermally releasable halogen in an amount of from about 1 to 49 mol % based on total silver in the material.

This invention also provides a method that comprises imaging the thermographic material of this invention with a thermal imaging source to provide a visible image.

When the thermographic material comprises a transparent support, the image-forming method can further comprise:
positioning the imaged thermographic material with the visible image thereon between a source of imaging radiation and an imageable material that is sensitive to the imaging radiation, and
thereafter exposing the imageable material to the imaging radiation through the visible image in the imaged thermographic material to provide an image in the imageable material.

We have found that the addition of specific halogen-containing compounds to the imaging composition of direct thermographic materials can be used to generate silver halide in image areas during development in the presence of a source of silver (for example, an organic silver salt). This silver halide acts as a catalyst so development can occur at lower temperatures. Since silver halide is produced only in the imaged areas, fog and printout are minimized.

Without being bound to a particular mechanism, it is believed that the specific halogen-containing compounds, when heated within the required temperature range in the presence of a source of silver, releases its halogen as a halogen free radical. This reactive halogen radical can be quickly reduced to a halide ion by obtaining an electron from one of many possible sources including the remaining organic fragment. The resulting halide ion and available silver ions can then form the silver halide catalyst. The process could be concerted in that the silver ion could be associated with the halogen while the bond is being broken between the halogen and the organic portion of the molecule. The temperature of halogen release depends upon the stability of the resulting halide and organic radicals. Thus, the halogen radical and organic radical of the halogen-containing compound must be properly matched to achieve the desired temperature for silver halide formation.

For example, a chloride radical is generally more reactive than a bromine radical that is more reactive than an iodine radical. The general order of organic radical stability is: benzyl, allyl>3°R>2°R>1°R>methyl>phenyl>vinyl [series from Neckers and Doyle, Organic Chemistry, Chapter 17, p. 574, (1977)]. Particularly useful chlorine-containing compounds would include organic compounds that are capable of forming a relatively stable organic radical since the chloride radical is quite reactive. If the organic radical is too stable, the generation of silver chloride will occur at too low of a temperature and if it is not stable enough, the processing temperature will be too high. In contrast, in order to generate silver iodide, the iodine-containing compound should form an organic radical of lower stability since iodide radicals are relatively stable and easily formed. Other structural factors are also important such as the ability to form unstrained ring intermediates, steric hindrance of the compound, its intermediates and its products, neighboring electron donating and electron withdrawing groups and neighboring heteroatoms.

Thus, from these considerations, it is understandable that, as determined in the present invention using Differential Scanning Calorimetry, silver 2-chloropropionate (chloro in the α-position to the carboxylate) releases its chlorine and forms silver chloride at 106° C., but silver 2-bromohexanoate (bromo in the α-position to the carboxylate) releases its bromine and forms silver bromide at 38° C. Moreover, silver 2-iodohippurate (iodo on phenyl) releases its iodine and forms silver iodide at 138° C. but di-silver tetrachlorophthalate (chloro on phenyl) does not release chlorine and form silver chloride below 200° C. Further details of useful compounds are provided below.

### BRIEF DESCRIPTION OF THE DRAWING

FIG. 1 is a graphical representation of some of the optical density vs. heating temperature data provided in TABLE II.

### DETAILED DESCRIPTION OF THE INVENTION

The direct thermographic materials can be used to provide black-and-white images using non-photosensitive organic silver salts, a reducing agent for silver ions, the halogen-containing compounds, binders, and other components known to be useful in such materials.

The direct thermographic materials can be used in black-and-white thermography and in electronically generated black-and-white hardcopy recording. They can be used as output media, in radiographic imaging (for example digital medical imaging), X-ray radiography, and in industrial radiography. Furthermore, the absorbance of these thermographic materials between 350 and 450 nm is desirably-low (less than 0.5), to permit their use in the graphic arts area (for example, in image-setting and phototypesetting operations), in the manufacture of printing plates, in contact printing, in duplicating (“duping”), and in proofing.

The direct thermographic materials are particularly useful as output media for medical imaging of human or animal subjects in response to thermal imaging means to provide a medical diagnosis. Such applications include, but are not limited to, thoracic imaging, mammography, dental imaging, orthopedic imaging, general medical radiography, therapeutic radiography, veterinary radiography, and auto-radiography.

In the direct thermographic materials, the components needed for imaging can be in one or more thermally sensitive layers on one side (“frontside”) of the support. The layer(s) that contain the non-photosensitive source of reducible silver ions are referred to herein as thermographic emulsion layer(s) or thermally sensitive imaging layer(s).

Where the materials contain thermographic imaging layers on one side of the support only, various non-imaging layers can be disposed on the “backside” (non-emulsion or non-imaging side) of the materials including an outermost slip layer and/or a conductive layer.

In such embodiments, various non-imaging layers can also be disposed on the “frontside,” imaging, or emulsion side of the support, including primer layers, interlayers, opacifying layers, subbing layers, carrier layers, antihalation layers, “slip” (or protective) layers, auxiliary layers, and other layers readily apparent to one skilled in the art.

For some embodiments, the direct thermographic materials may be “double-sided” or “duplitized” and have thermographic emulsion coating(s) or thermally sensitive imaging layer(s) on both sides of the support. In such constructions each side can also include one or more primer layers, interlayers, antistatic layers, auxiliary layers, conductive layers, “slip” (or protective) layers, and other layers readily apparent to one skilled in the art.

Differential Scanning Calorimetry (DSC) is a useful tool to measure the temperature at which silver halide is formed from halogen-containing compounds in the presence of a silver source. In general, this technique uses a calorimeter to measure heat liberated or adsorbed as a function of temperature as a sample is controllably heated. Samples that melt or change phases adsorb heat during the phase transition (the process is endothermic) while samples that are decomposing can either adsorb or liberate heat depending on the combined heats of reaction of the specific reactions taking place at that temperature. The reaction of specific interest in the present invention is the formation of silver halide from silver ions and halogen free radicals. The knowledge of all heats of reactions involved can be difficult and unnecessary to obtain but the easy determination of the temperature for the formation of silver halide for the halogen-containing compound is possible because a relatively large amount of heat is liberated due to the formation of silver halide (the process is exothermic). Note that the heat of formation (from the elements) of AgCl is −30.4 kcal/mol, AgBr is −24.0 kcal/mol, and AgI is −14.8 kcal/mol, (data from Handbook of Chemistry and Physics, 68^{th} ed., pg. D-84.)

Definitions

As used herein:

In the descriptions of the thermographic materials, “a” or “an” component refers to “at least one” of that component (for example, a halogen-containing compound).

Unless otherwise indicated, the term “halide” refers to “chloride”, “bromide”, and “iodide” but not fluoride.

The term “thermally releasable halogen” refers to the releasable halogen of the halogen-containing organic compound and does not suggest the specific mechanism by which this thermally releasable halogen becomes a halide ion and results in the formation of silver halide.

Unless otherwise indicated, the terms “thermographic material” or “direct thermographic material” are intended to be in reference to materials of the present invention.

“Thermographic material(s)” means a construction comprising at least one thermographic emulsion layer or therrnally sensitive imaging layer(s) wherein the source of reducible silver ions is in one layer and the other required components or optional additives are distributed, as desired, in the same layer or in an adjacent coated layers, as well as any supports, topcoat layers, image-receiving layers, carrier layers, blocking layers, conductive layers, antihalation layers, subbing or priming layers. These materials also include multilayer constructions in which one or more imaging components are in different layers, but are in “reactive association”. Thus, one layer can include the non-photosensitive source of reducible silver ions and another layer can include the reducing agent, but the two reactive components are in reactive association with each other.

When used in thermography, the term, “imagewise exposing” or “imagewise exposure” means that the material is imaged using any means that provides an image using heat. This includes, for example, analog exposure where an image is formed by differential contact heating through a mask using a thermal blanket or infrared heat source, as well as by digital exposure where the image is formed one pixel at a time such as by modulation of thermal print-heads or laser imaging sources.

The materials of this invention are “direct” thermographic materials in which imaging is either “on” or “off” (bimodal), and thermal imaging is carried out in a single “element” containing all of the necessary imaging chemistry. Direct thermal imaging is distinguishable from what is known in the art as thermal transfer imaging (such as dye transfer imaging) in which the image is produced in one element (“donor”) and transferred to another element (“receiver”) using thermal means.

“Catalytic proximity” or “reactive association” means that the components are in the same layer or in adjacent layers so that they readily come into contact with each other during thermal imaging and development.

“Emulsion layer,” “imaging layer,” or “thermographic emulsion layer,” means a thermally sensitive layer of a thermographic material that contains the non-photosensitive source of reducible silver ions. It can also mean a layer of the thermographic material that contains, in addition to the non-photosensitive organic silver salt, the halogen-containing compounds or additives. These layers are usually on what is known as the “frontside” of the support.

The slip layer is generally the outermost layer on the imaging side of the material that is in direct contact with the imaging means.

Many of the chemical components used herein are provided as a solution. The term “active ingredient” means the amount or the percentage of the desired material contained in a sample. All amounts listed herein are the amount of active ingredient added unless otherwise specified.

“Ultraviolet region of the spectrum” refers to that region of the spectrum less than or equal to 410 nm, and preferably from about 100 nm to about 410 nm. “Visible region of the spectrum” refers to that region of the spectrum of from about 400 nm to about 700 nm. “Infrared region of the spectrum” refers to that region of the spectrum of from about 700 nm to about 1400 nm.

“Non-photosensitive” means not intentionally light sensitive. The direct thermographic materials are non-photosensitive meaning that no photosensitive silver halide(s) has been purposely added.

The sensitometric terms, absorbance, contrast, Dₘᵢₙ, and Dₘₐₓ have conventional definitions known in the imaging arts. In thermographic materials, Dₘᵢₙ is considered herein as image density in the non-thermally imaged areas of the thermographic material. The sensitometric term absorbance is another term for optical density (OD).

“Transparent” means capable of transmitting visible light or imaging radiation without appreciable scattering or absorption.

As used herein, the phrase “silver organic coordinating ligand” refers to an organic molecule capable of forming a bond with a silver atom. Although the compounds so formed are technically silver coordination compounds they are also often referred to as organic silver salts.

The terms “double-sided”, “double-faced coating”, or “duplitized” are used to define thermographic materials having one or more of the same or different imaging layers disposed on both sides (front and back) of the support.

As a means of simplifying the discussion and recitation of certain substituent groups, the term “group” refers to chemical species that may be substituted as well as those that are not so substituted. Thus, the term “alkyl group” is intended to include not only pure hydrocarbon alkyl chains, such as methyl, ethyl, n-propyl, t-butyl, cyclohexyl, iso-octyl, and octadecyl, but also alkyl chains bearing substituents known in the art, such as hydroxyl, alkoxy, phenyl, halogen atoms (F, Cl, Br, and I), cyano, nitro, amino, and carboxy. Also, an alkyl group can include ether and thioether groups (for example CH₃—CH₂—CH₂—O—CH₂— and CH₃—CH₂—CH₂—S—CH₂—), haloalkyl, nitroalkyl, alkylcarboxy, carboxyalkyl, carboxamido, hydroxyalkyl, sulfoalkyl, and other groups readily apparent to one skilled in the art.

Research Disclosure is a publication of Kenneth Mason Publications Ltd., Dudley House, 12 North Street, Emsworth, Hampshire PO10 7DQ England. It is also available from Emsworth Design Inc., 147 West 24th Street, New York, N.Y. 10011.

Other aspects, advantages, and benefits of the present invention are apparent from the detailed description, examples, and claims provided in this application.

Non-Photosensitive Source of Reducible Silver Ions

The non-photosensitive source of reducible silver ions used in the direct thermographic materials can be any non-photosensitive, non-halogen-containing organic silver salt that contains reducible silver (1+) ions. Such compounds are generally non-halogen-containing silver salts of silver organic coordinating ligands. Preferably, it is a non-halogen-containing organic silver salt that is comparatively stable to light and forms a silver image when heated to 50° C. or higher in the presence of a reducing agent. Mixtures of these compounds can be used if desired.

Silver salts of organic acids including silver salts of long-chain carboxylic acids are preferred. The chains typically contain 10 to 30, and preferably 15 to 28, carbon atoms. Useful silver salts include a silver salt of an aliphatic carboxylic acid or a silver salt of an aromatic carboxylic acid (such as benzoates). Preferred examples of the silver salts of aliphatic carboxylic acids include silver behenate, silver arachidate, silver stearate, silver oleate, silver laurate, silver caprate, silver myristate, silver palmitate, silver maleate, silver fumarate, silver tartarate, silver furoate, silver linoleate, silver butyrate, silver camphorate, and mixtures thereof. Preferably, at least silver behenate is used alone or in mixtures with other silver salts.

Silver salts and di-silver salts of dicarboxylic acids are also useful including such silver salts as 1,10-decanedicarboxylic acid (or dodecanedioic acid) and 1,12-dodecanedicarboxylic acid (or tetradecanedioic acid).

In some embodiments, a highly crystalline silver behenate can be used as part or all of the non-photosensitive sources of reducible silver ions, as described in U.S. Pat. No. 6,096,486 (Emmers et al.) and U.S. Pat. No. 6,159,667 (Emmers et al.), both incorporated herein by reference. Moreover, the silver behenate can be used in its one or more crystallographic phases (such as a mixture of phases I, II and/or III) as described for example in EP 1 158 355A1 (Geuens et al.), incorporated herein by reference.

Other useful but less preferred silver salts include but are not limited to, silver salts of aromatic carboxylic acids and other carboxylic acid group-containing compounds, silver salts of aliphatic carboxylic acids containing a thioether group as described in U.S. Pat. No. 3,330,663 (Weyde et al.), silver carboxylates comprising hydrocarbon chains incorporating ether or thioether linkages, or sterically hindered substitution in the α-(on a hydrocarbon group) or ortho-(on an aromatic group) position, as described in U.S. Pat. No. 5,491,059 (Whitcomb), silver salts of aliphatic, aromatic, or heterocyclic dicarboxylic acids, silver salts of sulfonates as described in U.S. Pat. No. 4,504,575 (Lee), silver salts of sulfosuccinates as described in EP 0 227 141 A1 (Leenders et al.), silver salts of acetylenes as described in U.S. Pat. No. 4,761,361 (Ozaki et al.) and U.S. Pat. No. 4,775,613 (Hirai et al.), silver salts of compounds containing mercapto or thione groups and derivatives thereof (such as those having a heterocyclic nucleus containing 5 or 6 atoms in the ring, at least one of which is a nitrogen atom), as described in U.S. Pat. No. 4,123,274 (Knight et al.) and U.S. Pat. No. 3,785,830 (Sullivan et al.), silver salts of mercapto or thione substituted compounds that do not contain a heterocyclic nucleus, silver salts of compounds containing an imino group (such as silver salts of benzotriazole and substituted derivatives thereof), silver salts of 1,2,4-triazoles or 1-H-tetrazoles as described in U.S. Pat. No. 4,220,709 (deMauriac), and silver salts of imidazoles and imidazole derivatives as described in U.S. Pat. No. 4,260,677 (Winslow et al.), silver triazolates, silver sulfonates, silver sulfosuccinates, and silver acetylides.

The methods used for making silver soap emulsions are well known in the art and are disclosed in Research Disclosure, April 1983, item 22812, Research Disclosure, October 1983, item 23419, U.S. Pat. No. 3,985,565 (Gabrielsen et al.), and the references cited above.

Non-photosensitive silver salts can also be provided as core-shell silver salts such as those described in U.S. Pat. No. 6,355,408 (Whitcomb et al.), that is incorporated herein by reference, or as silver dimer compounds that comprise two different silver salts as described in U.S. Pat. No. 6,472,131 (Whitcomb), that is also incorporated herein by reference.

The non-photosensitive organic silver salts can also be provided in the form of an aqueous nanoparticulate dispersion of silver salt particles (such as silver carboxylate particles). The silver salt particles in such dispersions generally have a weight average particle size of less than 1000 nm when measured by any useful technique such as sedimentation field flow fractionation, photon correlation spectroscopy, or disk centrifugation. Obtaining such small silver salt particles can be achieved using a variety of techniques but generally they are achieved using high-speed milling using a device such as those manufactured by Morehouse-Cowles and Hochmeyer. The details for such milling are well known in the art.

Such dispersions also advantageously include a surface modifier so the silver salt can more readily be incorporated into aqueous-based photothermographic formulations. Useful surface modifiers include, but are not limited to, vinyl polymers having an amino moiety, such as polymers prepared from acrylamide, methacrylamide, or derivatives thereof, as described in U.S. Pat. No. 6,391,537 (Lelental et al.), incorporated herein by reference. A particularly useful surface modifier is dodecylthiopolyacrylamide that can be prepared as described in the noted copending application using the teaching provided by Pavia et al., Makromoleculare Chemie, 193(9), 1992, pp. 2505-17.

Other useful surface modifiers are phosphoric acid esters, such as mixtures of mono- and diesters of orthophosphoric acid and hydroxy-terminated, oxyethylated long-chain alcohols or oxyethylated alkyl phenols as described for example in U.S. Pat. No. 6,387,611 (Lelental et al.), incorporated herein by-reference. Particularly useful phosphoric acid esters are commercially available from several manufacturers under the trademarks or tradenames EMPHOS™ (Witco Corp.), RHODAFAC (Rhone-Poulenc), T-MULZ® (Hacros Organics), and TRYFAC (Henkel Corp./Emery Group).

Such dispersions contain smaller particles and narrower particle size distributions than dispersions that lack such surface modifiers. Particularly useful nanoparticulate dispersions are those comprising silver carboxylates such as silver behenate. These nanoparticulate dispersions can be used in combination with the conventional silver salts described above including silver benzotriazole.

The non-photosensitive, non-halogen-containing organic silver salts are generally present in an amount of from about 5% to about 70% (more preferably from about 10% to about 50%), based on the total dry weight of the emulsion layers. Stated another way, these organic silver salts are generally present in an amount of from about 0.001 to about 0.2 mol/m² of the thermo-graphic material (preferably from about 0.002 to about 0.02 mol/m²).

Further, these non-halogen-containing organic silver salts provide at least 51 mole % of the total silver in the thermographic material. Preferably, they provide from 51 to 100 mole % and more preferably from about 60 to 100 mole % of the total silver in the thermographic material. The amount of total silver is generally from about 0.002 to about 0.03 mol/m² and preferably from about 0.005 to about 0.02 mol/m².

Reducing Agents

The reducing agent (or reducing agent composition comprising two or more components) for reducing the reducible silver ions can be any material (preferably an organic material) that can reduce silver (1+) ion to metallic silver. For example, useful reducing agents are organic compounds containing at least one active hydrogen atom linked to an oxygen, nitrogen, or carbon atom. These reducing agents may also be known in the art as “black-and-white” developers or developing agents. Mixtures of reducing agents can be used if desired.

Conventional photographic developers can be used as reducing agents, including aromatic di- and tri-hydroxy compounds such as dihydroxybenzenes (including 2,3- and 3,4-dihydroxybenzenes) such as those described in EP 1,270,255A1 (noted above), trihydroxybenzene compounds, alkoxynaphthols, pyrazolidin-3-one type reducing agents, pyrazolin-5-ones, polyhydroxy spiro-bis-indanes, indan-1,3-dione derivatives, hydroxytetrone acids, hydroxytetronimides, hydroxylamine derivatives such as for example those described in U.S. Pat. No. 4,082,901 (Laridon et al.), hydrazine derivatives, hindered phenols, amidoximes, azines, reductones (for example, ascorbic acid and ascorbic acid derivatives), and other materials readily apparent to one skilled in the art.

When used with a silver carboxylate silver source in a thermo-graphic material, preferred reducing agents are aromatic di- and tri-hydroxy compounds having at least two hydroxy groups in ortho- or para-relationship on the same aromatic nucleus. Examples are hydroquinone and substituted hydroquinones, catechols, pyrogallol, gallic acid and gallic acid esters, tannic acid, dihydroxybenzenes, and trihydroxybenzenes.

Particularly preferred are reducing catechol-type reducing agents having no more than two hydroxy groups in an ortho-relationship. Preferred catechol-type reducing agents include, for example, catechol, 3-(3,4-dihydroxy-phenyl)propionic acid, 2,3-dihydroxy-benzoic acid, 2,3-dihydroxy-benzoic acid esters, 3,4-dihydroxy-benzoic acid, and 3,4-dihydroxy-benzoic acid esters.

One particularly preferred class of catechol-type reducing agents are benzene compounds in which the benzene nucleus is substituted by no more than two hydroxy groups which are present in 2,3-position on the nucleus and have in the 1-position of the nucleus a substituent linked to the nucleus by means of a carbonyl group. Compounds of this type include 2,3-dihydroxy-benzoic acid, methyl 2,3-dihydroxy-benzoate, and ethyl 2,3-dihydroxy-benzoate.

Another useful class of catechol-type reducing agents are benzene compounds in which the benzene nucleus is substituted by no more than two hydroxy groups that are present in 3,4-position on the nucleus and have in the 1-position of the nucleus a substituent linked to the nucleus by means of a carbonyl group. Compounds of this type include, for example, 3,4-dihydroxy-benzoic acid, methyl 3,4-dihydroxy-benzoate, ethyl 3,4-dihydroxy-benzoate, butyl 3,4-dihydroxybenzoate, 3,4-dihydroxy-benzaldehyde, and phenyl-(3,4-dihydroxy-phenyl)ketone. Such compounds are described, for example, in U.S. Pat. No. 5,582,953 (Uyttendaele et al.), that is incorporated herein by reference.

Still another particularly useful class of reducing agents includes polyhydroxy spiro-bis-indane compounds that are described in U.S. Pat. No. 3,440,049 (Moede) and U.S. Pat. No. 5,817,598 (Defieuw et al.), both incorporated herein by reference.

In some constructions, “hindered phenol reducing agents” can be used. “Hindered phenol reducing agents” are compounds that contain only one hydroxy group on a given phenyl ring and have at least one additional substituent located ortho to the hydroxy group. Hindered phenol reducing agents may contain more than one hydroxy group as long as each hydroxy group is located on different phenyl rings. Hindered phenol reducing agents include, for example, binaphthols (that is dihydroxybinaphthyls), biphenols (that is dihydroxybiphenyls), bis(hydroxynaphthyl)methanes, bis(hydroxyphenyl)methanes (that is bisphenols), hindered phenols, and hindered naphthols, each of which may be variously substituted. Representative compounds are described in U.S. Pat. No. 3,094,417 (Workman) and U.S. Pat. No. 5,262,295 (Tanaka et al.), both incorporated herein by reference.

In some instances, a reducing agent composition comprises two or more components such as a hindered phenol developer and a co-developer that can be chosen from the various known classes of co-developers. Ternary developer mixtures involving the further addition of contrast enhancing agents are also useful. Such contrast enhancing agents can be chosen from the various classes of reducing agents described below. Useful co-developer reducing agents are as described for example, in U.S. Pat. No. 6,387,605 (Lynch et al.) that is incorporated herein by reference.

Additional classes of reducing agents that can be used as co-developers are trityl hydrazides and formyl phenyl hydrazides as described in U.S. Pat. No. 5,496,695 (Simpson et al.), 2-substituted malondialdehyde compounds as described in.U.S. Pat. No. 5,654,130 (Murray), and 4-substituted isoxazole compounds as described in U.S. Pat. No. 5,705,324 (Murray). Additional co-developers are described in U.S. Pat. No. 6,100,022 (Inoue et al.). All of the patents above are incorporated herein by reference.

Yet another class of co-developers includes substituted acrylonitrile compounds that are described in U.S. Pat. No. 5,635,339 (Murray) and U.S. Pat. No. 5,545,515 (Murray et al.), both incorporated herein by reference.

Additional reducing agents that have been disclosed in dry silver systems including amidoximes, azines, a combination of aliphatic carboxylic acid aryl hydrazides and ascorbic acid, a combination of polyhydroxybenzene and hydroxylamine, a reductone and/or a hydrazine, hydroxamic acids, a combination of azines and sulfonamido phenols, α-cyanophenylacetic acid derivatives, bis-o-naphthols, a combination of bis-o-naphthol and a 1,3-dihydroxybenzene derivative, 5-pyrazolones, reductones, sulfonamidophenol reducing agents, indane-1,3-diones, chromans, 1,4-dihydropyridines, and 3-pyrazolidones.

Yet another useful additional reducing agent are hydroxy-substituted diphenylsulfones such as 4-methyl-3′,4′,5′-trihydroxy-diphenylsulfone.

The reducing agent (or mixture thereof) described herein is generally present in an amount greater than 0.1 mole per mole of silver and at 1 to 10% (dry weight) of the thermographic emulsion layer. In multilayer constructions, if the reducing agent is added to a layer other than an emulsion layer, slightly higher proportions, of from about 2 to 15 weight % may be more desirable. Any co-developers may be present generally in an amount of from about 0.001% to about 1.5% (dry weight) of the thermographic emulsion layer coating.

Halogen-Containing Organic Compounds

The thermographic materials also include one or more halogen-containing organic compounds, each of which has at least 2 carbon atoms and is capable of thermally releasing a halogen that forms silver halide in imaged areas when heated to a temperature between 60 and 141° C. (preferably between 80 and 130° C.) in the presence of a silver source. The silver source can be either the halogen-containing organic compound if it is present as a silver salt, or the non-photosensitive, non-halogen-containing organic silver salt present in the imaging layer, or both. Mixtures of two or more of these halogen-containing organic compounds can be used if desired.

In some embodiments, the halogen-containing organic compound has fewer carbon atoms than the non-photosensitive, non-halogen-containing organic silver salt described above.

Preferably, such compounds are carboxylic acids or their salts having at least 2 carbon atoms and are capable of releasing their halogen that forms silver chloride, silver bromide, or silver iodide (or a mixture thereof when mixture of compounds are used), respectively, when heated to a temperature between 60 and 141° C. in the presence of a source of silver. For example, the compounds can be silver salts of halogen-containing carboxylic acids (or alkali metal salts thereof), including di-carboxylic acids.

In some embodiments, the thermographic materials include the non-photosensitive, non-halogen-containing organic silver salt at a concentration of from 51 to about 99 mol % based on total silver and a halogen-containing organic silver salt at a concentration of from about 1 to 49 mol % based on total silver. In such embodiments, the thermographic materials have at least two organic silver salts, one that is halogenated and the other that is not. The non-halogenated organic silver is the “predominant” organic silver salt, meaning that is comprises at least 51 mol % of the total silver in the material.

In other embodiments, the halogen-containing organic compound is a silver salt of an α-chlorocarboxylic acid (or alkali metal salt thereof) that is capable of releasing its chlorine to form silver chloride when heated to a temperature of between 80 and 140° C. in the presence of a source of silver.

In one preferred embodiment, the halogen-containing organic compound is a silver salt of an α-chlorocarboxylic acid that is represented by the following Structure (I):
R—CH(Cl)-COOAg (I)
wherein R is an aliphatic or cyclic group having a molecular weight of at least 15 and up to 600 (preferably up to 350). Examples of aliphatic groups having at least 1 carbon atom and up to 24 carbon atoms, include straight or branched-chain hydrocarbon groups that can be unsubstituted or substituted with one or more hydroxy, thioether, or ether groups. Examples of cyclic groups include 5- to 6-membered carbocyclic groups that can be unsubstituted or substituted with one or more alkyl or phenolic groups. Preferably, R is an aliphatic group having at least 1 carbon atom. R can also be an aliphatic group having another acid group or alkali metal salt thereof.

In still other embodiments, the thermographic materials contain a halogen-containing organic compound that is a silver salt of a halogen-containing carboxylic acid and a second halogen-containing organic compound that is not a silver salt.

Non-limiting examples of useful halogen-containing organic compounds include trichloroacetic acid, 2-chloroacetophenone, 2-bromodecane, (2-iodoethyl)benzene, 2-chlorostearic acid, 2-chloropropionic acid, 2-bromohexadecanoic acid, 6-bromohexadecanoic acid, and 2-iodohippuric acid, and where possible, alkali metal, alkaline earth, and silver salts thereof.

The most preferred halogen-containing organic compounds are 2-chlorostearic acid, 2-chloropropionic acid, 2-bromohexadecanoic acid, 6-bromohexadecanoic acid, 2-bromohexanoic acid, 1-iodohexadecane, (2-iodoethyl)benzene, and 2-iodohippuric acid, myristic acid, and where possible, alkali metal, alkaline earth, or silver salts thereof.

The most preferred halogen-containing silver salts include silver salts of 2-chlorostearic acid, 2-chloropropionic acid, 2-bromohexadecanoic acid, 6-bromohexadecanoic acid, and 2-iodohippuric acid.

The halogen-containing organic compounds can be obtained from a number of commercial sources (such as Aldrich Chemical Company) or prepared using known starting materials and synthetic methods.

The halogen-containing organic compounds are present in the thermographic materials in amounts that provide thermally releasable halogen in an amount of from about 1 to about 49 mol %, and preferably from about 2 to about 20 mol %, based on total silver in the material.

The halogen-containing organic compounds capable of thermally forming silver halide within the temperature range of interest can be determined using DSC or X-ray powder diffraction. The compound of interest must be silver salt of mixed with a source of silver, preferably in a molar equivalent ratio to the thermally releasable halogen to maximize the heat liberated or the amount of silver halide created to improve detection. A halogen-containing organic compound may have more than one halogen atom per molecule but may note be of a thermally releasable type. Only the “potentially” releasable halogen atoms would be included in the determination of % mol or “thermally releasable halogen” according to the present invention.

Other Addenda

The thermographic materials can also contain other additives such as toning agents, shelf-life stabilizers, contrast enhancers, dyes or pigments, post-processing stabilizers or stabilizer precursors, thermal solvents (also known as melt formers), and other image-modifying or development-modifying agents as would be readily apparent to one skilled in the art.

Suitable stabilizers that can be used alone or in combination include thiazolium salts as described in U.S. Pat. No. 2,131,038 (Staud) and U.S. Pat. No. 2,694,716 (Allen), azaindenes as described in U.S. Pat. No. 2,886,437 (Piper), triazaindolizines as described in U.S. Pat. No. 2,444,605 (Heimbach), the urazoles as described in U.S. Pat. No. 3,287,135 (Anderson), sulfocatechols as described in U.S. Pat. No. 3,235,652 (Kennard), oximes as described in GB 623,448 (Carrol et al.), polyvalent metal salts as described in U.S. Pat. No. 2,839,405 (Jones), thiuronium salts as described in U.S. Pat. No. 3,220,839 (Herz), palladium, platinum, and gold salts as described in U.S. Pat. No. 2,566,263 (Trirelli) and U.S. Pat. No. 2,597,915 (Damshroder), compounds having —SO₂CBr₃ groups as described for example in U.S. Pat. No. 5,594,143 (Kirk et al.) and U.S. Pat. No. 5,374,514 (Kirk et al.), and 2-(tribromomethylsulfonyl)quinoline compounds as described in U.S. Pat. No. 5,460,938 (Kirk et al.).

Stabilizer precursor compounds capable of releasing stabilizers upon application of heat during imaging can also be used. Such precursor compounds are described in for example, U.S. Pat. No. 5,158,866 (Simpson et al.), U.S. Pat. No. 5,175,081 (Krepski et al.), U.S. Pat. No. 5,298,390 (Sakizadeh et al.), and U.S. Pat. No. 5,300,420 (Kenney et al.).

In addition, certain substituted-sulfonyl derivatives of benzotriazoles may be used as stabilizing compounds as described in U.S. Pat. No. 6,171,767 (Kong et al.) and U.S. Pat. No. 6,083,681 (Lynch et al.).

The thermographic materials may also include one or more thermal solvents (or melt formers) as disclosed in U.S. Pat. No. 3,438,776 (Yudelson), U.S. Pat. No. 5,250,386 (Aono et al.), U.S. Pat. No. 5,368,979 (Freedman et al.), U.S. Pat. No. 5,716,772 (Taguchi et al.), and U.S. Pat. No. 6,013,420 (Windender).

Toning agents that improve the image are also desirable components of the thermographic materials of this invention. Toning agents (also referred to as “toners”) can modify a thermographic material is several ways: (1) increasing image density for a given amount of coated silver, (2) improving the rate of development thereby reducing processing time, and (3) shifting the color of the image from yellowish-orange to brown-black or blue-black. One or more toning agents may be present in an amount of from about 0.01% to about 10% (more preferably from about 0.1% to about 10%), based on the total dry weight of the layer in which it is included. Toning agents may be incorporated in any imaging or non-imaging layer.

Toning agents are well known materials in the art, as shown in U.S. Pat. No. 3,080,254 (Grant, Jr.), U.S. Pat. No. 3,847,612 (Winslow), U.S. Pat. No. 4,123,282 (Winslow), U.S. Pat. No. 4,082,901 (Laridon et al.), U.S. Pat. No. 3,074,809 (Owen), U.S. Pat. No. 3,446,648 (Workman), U.S. Pat. No. 3,844,797 (Willems et al.), U.S. Pat. No. 3,951,660 (Hagemann et al.), and U.S. Pat. No. 5,599,647 (Defieuw et al.) and in GB 1,439,478 (AGFA).

Examples of toning agents include phthalimide and N-hydroxyphthalimide, cyclic imides, pyrazoline-5-ones, quinazolinone, 1-phenylurazole, 3-phenyl-2-pyrazoline-5-one, and 2,4-thiazolidinedione, naphthalimides, cobalt complexes, mercaptans, N-(aminomethyl)aryldicarboximides, a combination of blocked pyrazoles, isothiuronium derivatives, and certain photobleach agents, merocyanine dyes, phthalazine and derivatives thereof [such as those described in U.S. Pat. No. 6,146,822 (Asanuma et al.)], phthalazinone and phthalazinone derivatives, or metal salts or these derivatives, a combination of phthalazine (or derivative thereof) plus one or more phthalic acid derivatives, quinazolinediones, benzoxazine or naphthoxazine derivatives, rhodium complexes functioning not only as tone modifiers but also as sources of halide ion for silver halide formation in-situ, benzoxazine-2,4-diones and naphthoxazine diones as described in U.S. Pat. No. 5,817,598 (noted above), pyrimidines, asym-triazines, and tetraazapentalene derivatives.

Also useful are the phthalazine compounds described in U.S. Pat. No. 6,605,418 (Ramsden et al.), the triazine thione compounds described in U.S. Pat. No. 6,703,191 (Lynch et al.), and the heterocyclic disulfide compounds described in U.S. Pat. No. 6,737,227 (Lynch et al.), all of which are incorporated herein by reference.

The thermographic materials may also include one or more polycarboxylic acids and/or anhydrides thereof that are in thermal working relationship with the sources of reducible silver ions. Such polycarboxylic acids can be substituted or unsubstituted aliphatic or aromatic compounds. They can be used in anhydride or partially esterified form as long as two free carboxylic acids remain in the molecule. Useful polycarboxylic acids are described for example in U.S. Pat. No. 6,096,486 (noted above).

Binders

The non-photosensitive organic silver salt, the reducing agent, halogen-containing compound, and any other additives used in the present invention are generally mixed with one or more binders to form a coating formulation.

In some embodiments, the binders are predominantly (at least 50% by weight of total binders) hydrophilic in nature and aqueous solvent-based formulations are used to prepare such thermographic materials. Mixtures of hydrophilic binders can also be used.

Examples of useful hydrophilic binders that can be used include proteins and protein derivatives, gelatin and gelatin-like derivatives (hardened or unhardened), cellulosic materials, acrylamide/methacrylamide polymers, acrylic/methacrylic polymers polyvinyl pyrrolidones, polyvinyl alcohols, poly(vinyl lactams), polymers of sulfoalkyl acrylate or methacrylates, hydrolyzed polyvinyl acetates, polyacrylamides, polysaccharides, and other synthetic or naturally occurring vehicles commonly known for use in aqueous-based imaging emulsions.

Water-dispersible binders including water-dispersible polymer latexes can also be used in the thermographic materials of this invention. Such materials are well known in the art including U.S. Pat. No. 6,096,486 (noted above).

In other embodiments, the binders are predominantly (at least 50 weight % of total binder weight) hydrophobic in nature and organic-solvents formulations are used to prepare such thermographic materials. Examples of useful hydrophobic binders include polyvinyl acetals, polyvinyl chloride, polyvinyl acetate, cellulose acetate, cellulose acetate butyrate, polyolefins, polyesters, polystyrenes, polyacrylonitrile, polycarbonates, methacrylate copolymers, maleic anhydride ester copolymers, butadiene-styrene copolymers, and other materials readily apparent to one skilled in the art. Copolymers (including terpolymers) are also included in the definition of polymers. The polyvinyl acetals (such as polyvinyl butyral and polyvinyl formal), cellulose ester polymers, and vinyl copolymers (such as polyvinyl acetate and polyvinyl chloride) are preferred. Particularly suitable binders are polyvinyl butyral resins that are available as BUTVAR® B79 (Solutia, Inc.) and PIOLOFORM® BS-18 or PIOLOFORM® BL-16 (Wacker Chemical Company) and cellulose ester polymers.

The polymer binder(s) is used in an amount sufficient to carry the components dispersed therein. Generally, one or more binders are used at a level of about 10% by weight to about 90% by weight (more preferably at a level of about 20% by weight to about 70% by weight) based on the total dry weight of the layer in which it is included.

Support Materials

The thermographic materials comprise a polymeric support that is preferably a flexible, transparent film that has any desired thickness and is composed of one or more polymeric materials, depending upon their use. The supports are generally transparent (especially if the material is used as a photomask) or at least translucent, but in some instances, opaque supports may be useful. They are required to exhibit dimensional stability during thermal imaging and development and to have suitable adhesive properties with overlying layers. Useful polymeric materials for making such supports include polyesters, cellulose acetate and other cellulose esters, polyvinyl acetal, polyolefins, polycarbonates, and polystyrenes. Preferred supports are composed of polyesters and polycarbonates.

Support materials can contain various colorants, pigments, and antihalatiori or acutance dyes if desired. For example, the support can contain conventional blue dyes that differ in absorbance from colorants in the various frontside or backside layers as described in U.S. Pat. No. 6,248,442 (Van Achere et al.). Support materials may be treated using conventional procedures (such as corona discharge) to improve adhesion of overlying layers, or subbing or other adhesion-promoting layers can be used, or treated or annealed to promote dimensional stability.

The thermographic materials preferably have an outermost slip or protective layer on at least the imaging side of the support comprising useful components such as one or more specific lubricants and/or matting agents that are known in the art. The matting agents can be composed of any useful material and may have a size in relation to the slip layer thickness that enables them to protrude through the outer surface of the conductive layer, as described for example, in U.S. Pat. No. 5,536,696 (Horsten et al.). Particularly useful combinations of lubricants are described in copending and commonly assigned U.S. Ser. No. 10/767,757 (filed on Jan. 28, 2004 by Kenney, Foster, and Johnson) that is incorporated herein by reference.

Thermographic Formulations

An organic-based formulation for the thermographic emulsion layer(s) can be prepared by dissolving and dispersing the binder, the organic silver salt, the reducing agent, halogen-containing compound, and optional addenda in an organic solvent, such as toluene, 2-butanone (methyl ethyl ketone), acetone, or tetrahydrofuran (or mixtures thereof). If an aqueous-based formulation is used for the preferred embodiments, a similar dispersion is made in an aqueous solvent that comprises at least 50 volume % water. Some of the components may not be water-soluble and thus may need to be dispersed in organic solvents that are miscible with the solvent used to make the formulation.

The thermographic materials can be constructed of two or more layers on the imaging side of the support. Two-layer materials would include a single imaging layer and an outermost protective layer. The single imaging layer would contain all of the components needed for imaging, those components desired for the present invention, as well as optional materials such as toning agents, development accelerators, thermal solvents, coating aids, and other additives.

Layers or polymeric materials to promote adhesion in thermographic materials are described for example in U.S. Pat. No. 5,891,610 (Bauer et al.), U.S. Pat. No. 5,804,365 (Bauer et al.), U.S. Pat. No. 4,741,992 (Przezdziecki), and U.S. Pat. No. 5,928,857 (Geisler et al.).

Layers to reduce emissions from the film may also be present as described in U.S. Pat. No. 6,352,819 (Kenney et al.), U.S. Pat. No. 6,352,820 (Bauer et al.), U.S. Pat. No. 6,420,102 (Bauer et al.), and U.S. Pat. No. 6,746,831 (Hunt), all incorporated herein by reference.

Layer formulations described herein can be coated by various coating procedures including wire wound rod coating, dip coating, air knife coating, curtain coating, slide coating, or extrusion coating. The formulations can be coated one at a time, or two or more formulations can be coated simultaneously by the procedures described in the art.

When the layers are coated simultaneously using various coating techniques, a “carrier” layer formulation comprising a single-phase mixture of the two or more polymers described above may be used as described in U.S. Pat. No. 6,436,622 (Geisler), incorporated herein by reference.

Preferably, two or more layers are applied to a film support using slide coating with the first layer coated on top of the second layer while the second layer is still wet using the same or different solvents (or solvent mixtures).

While the first and second layers can be coated on one side of the film support, manufacturing methods can also include forming one or more layers on the opposing or backside of said polymeric support.

Preferred embodiments include a conductive layer on one or both sides of the support, and more preferably on the backside of the support. Various conductive materials are known in the art such as soluble salts, evaporated metal layers, or ionic polymers as described in U.S. Pat. No. 2,861,056 (Minsk) and U.S. Pat. No. 3,206,312 (Sterman et al.), insoluble inorganic salts as described in U.S. Pat. No. 3,428,451 (Trevoy), electroconductive underlayers as described in U.S. Pat. No. 5,310,640 (Markin et al.), and electrically-conductive metal-containing particles dispersed in a polymeric binder as described in EP 0 678 776A1 (Melpolder et al.). In addition, fluorochemicals such as Fluorad® FC-135 (3M Corporation), ZONYL® FSN (E. I. DuPont de Nemours & Co.), as well as those described in U.S. Pat. No. 5,674,671 (Brandon et al.), U.S. Pat. No. 6,287,754 (Melpolder et al.), U.S. Pat. No. 4,975,363 (Cavallo et al.), U.S. Pat. No. 6,171,707 (Gomez et al.), U.S. Pat. No. 6,699,648 (Sakizadeh et al.), and U.S. Pat. No. 6,762,013 (Sakizadeh et al.) can be used. All of these patents are incorporated herein by reference.

In preferred embodiments, the conductive layer includes one or more specific non-acicular metal antimonate particles such as non-acicular metal antimonate particles composed of ZnSb₂O₆ as described in U.S. Pat. No. 6,689,546 (LaBelle et al.), incorporated herein by reference.

Imaging/Development

The thermographic materials can be imaged in any suitable manner consistent with the type of material using any suitable source of thermal energy. The image may be “written” simultaneously with development at a suitable temperature using a thermal stylus, a thermal print head, or a laser, or by heating while in contact with a heat-absorbing material. The thermographic materials may include a dye (such as an IR-absorbing dye) to facilitate direct development by exposure to laser radiation.

Use as a Photomask

The thermographic materials are sufficiently transmissive in the range of from about 350 to about 450 nm in non-imaged areas to allow their use in a method where there is a subsequent exposure of an ultraviolet or short wavelength visible radiation sensitive imageable medium. The materials may then be used as a mask and positioned between a source of imaging radiation (such as an ultraviolet or short wavelength visible radiation energy source) and an imageable material that is sensitive to such imaging radiation, such as a photopolymer, diazo material, photoresist, or photosensitive printing plate.

In such embodiments, the imaging method of this invention can further comprise:
positioning the imaged thermographic material with the visible image thereon between a source of imaging radiation and an imageable material that is sensitive to the imaging radiation, and
thereafter exposing said imageable material to the imaging radiation through the visible image in the imaged thermographic material to provide an image in the imageable material.

The following examples are provided to illustrate the practice of the present invention and the invention is not meant to be limited thereby.

Materials and Methods for the Examples:

“TBrMSQ” is 2-(tribromomethylsulfonyl)quinoline that is described in U.S. Pat. No. 5,460,938 (Kirk et al.).

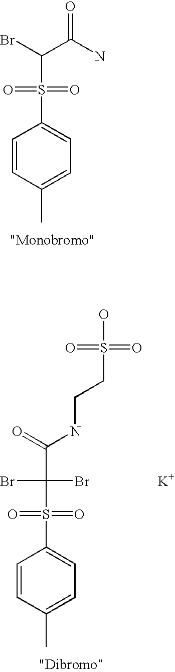

Water used in the preparations was deionized and low in chloride ions.

Silver Behenate Preparation:

To a well-stirred solution consisting of 22.7 kg of water, 2.500 kg of methanol, and 111.14 g of NaOH (2.78 mole), at 70° C., was added 1036.9 g of behenic acid (3.044 mole), (nominally 90% behenic acid recrystallized from isopropanol to purify). The mixture was heated to 90° C. and held at this temperature for 30 minutes. The mixture was then cooled to 70° C. and 857.9 g of a 5.72M solution of AgNO₃ (2.77 moles) was added over 30 minutes and then held at this temperature for an additional 30 minutes. The resulting mixture was cooled to 25° C. and the resulting product was filtered and washed repeatedly until the wash water had a conductivity of less than 1000 μS/cm. The resulting solid product was dried in a vacuum oven for 3 days at 50° C.

Preparation of 2-chlorostearic Acid:

This acid was prepared from stearic acid using the preparative procedure described in R. Crawford, J. Org. Chem. 48, pgs. 1364-1366, (1983).

Preparation of Silver 2-chlorostearate:

A mixture of 650 g of water, 82 g of methanol, 94.6 g of 1.0M NaOH solution (0.091 mole), and 31.9 g of 2-chlorostearic acid (0.10 mole) was heated briefly to 66° C. to dissolve the acid. At 50° C. and with good stirring were added 103.5 g of a 11.0M AgNO₃ solution (0.091 mole) at 9 ml/min. Then the mixture was cooled to 40° C. and 400 g of water were added and the mixture was centrifuged. The solid portion was resuspended in water to 1200 g and centrifuged. This washing process was repeated a total of 8 times. The resulting paste was freeze dried to yield a white free-flowing powder. Neutron activation analysis for silver showed that the product contained the expected ˜90 mole % Ag 2-chlorostearate (the remainder being the unreacted 2-chlorostearic acid and its sodium salt).

Preparation of di-silver 2,3-dichlorossuccinic Acid:

Maleic acid (11.6 g, 0.10 mole) in 200 ml of acetic acid was stirred at 40° C. while chlorine gas (˜17 g, 0.24 mole) was bubbled in. The solution was reduced to ˜70 ml and the resulting crystals were filtered and washed with cold acetic acid and vacuum dried overnight at 85° C. Mass spectral analysis showed the product was mostly 2,3-dichlorossuccinic acid and contained some maleic acid.

To a mixture of 2,3-dichlorosuccinic acid (2.34 g) in 18 g of water at 20° C. was added a 5M NaOH solution to adjust the pH to 7.3. To the resulting solution, 5.0 ml of 5M AgNO₃ was rapidly added. The mixture was stirred an additional 10 minutes and the solid phase was separated and centrifuge washed twice with 100 ml of chilled water. The product was freeze-dried to a white free-flowing powder. Samples of this powder were exposed to fluorescent lighting (about 65 foot-candles or 699 lux) at ˜30% and 77% relative humidity. After 24 hours of 30% RH, the powder remained white but the powder in the 77% RH noticeably darkened in just 1 hour. This shows that this silver salt has relatively good photo-stability but easily releases silver chloride through hydrolysis.

Preparation of Silver Myristate:

A mixture of 650 g of water, 82 g of methanol, 94.6 g of a 1.0M NaOH solution (0.091 mole), and 22.8 g of myristic acid (0.10 mole) was heated to 70° C. with good stirring. When the acid had dissolved, 103.5 g of a 1.0M AgNO₃ solution (0.091 mole) was added at 9 ml/min. The mixture was held at 70° C. for 30 minutes. Then the mixture was cooled to 40° C. and 400 g of water were added and the mixture was centrifuged. The solid portion was resuspended in water to 1200 g and centrifuged. This washing process was repeated a total of 3 times. The resulting paste was freeze-dried to yield a white free flowing powder.

Preparation of Silver 1,12-dodecanedicarboxylate:

A mixture of 650 g of water, 187.2 g of a 1.0M NaOH solution (0.18 mole), and 24.5 g of 1,12-dodecanedicarboxylic acid (0.095 mole) was heated briefly to 88° C. to dissolve the acid. At 56° C. and with good stirring, a 1.0M NaOH solution was added until the pH started to increase rapidly (6.80 g required, 0.00654 mole, pH=8.80). To the clear solution at 60° C., with good stirring, were added 216.2 g of a 1.0M AgNO₃ solution (0.190 mole) at 10 ml/min. The resulting suspension was stirred for an additional 15 minutes at 60° C. Then the mixture was cooled to 40° C. and 400 g of water was added and the mixture was centrifuged. The solid portion was resuspended in water to 1200 g and centrifuged. This washing process was repeated a total of 6 times. The resulting paste was freeze-dried to yield a white free flowing powder. Neutron activation analysis for silver showed that the product contained 44.1 mole % Ag. The theoretical for 2 silvers per molecule is 45.7%. X-Ray powder diffraction analysis showed this compound has a layered structure having a repeat separation of 20.7 Å. The calculated repeat separation, assuming the methylene groups to be in all trans configuration and one molecule per repeat unit, is 21.1 Å. By comparison, silver behenate is known to have a layered structure having two molecules per repeat unit.

Preparation of Silver 2-chloropropionate:

To a well-mixed solution of 200 g of water and 81.4 g of 2-chloropropionic acid (0.75 mole) was added a 5.0M NaOH solution at 20° C. until the pH was 6.84 (˜0.75 mole required). Then, 251.8 g (0.75 mole) of a 5.0M AgNO₃ solution were rapidly poured in with vigorous mixing. The mixture was stirred an additional 5 minutes at 20° C. The resulting suspension was centrifuged and the solid phase was shaken with 500 ml of chilled water, centrifuged, and finally the solid phase was freeze-dried to a white free-flowing powder.

Preparation of Sodium 2-chloropropionate:

To a well-mixed solution of 20 g of water and 8.1 g of 2-chloropropionic acid (0.075 mole) was added a 5.0M NaOH solution to adjust the pH to 6.84 (˜0.075 mole). The water was removed under vacuum and the resulting solid was ground to a free-flowing powder.

Preparation of Silver 3-chloropropionate:

The above procedure was repeated except that 81.4 g of 3-chloropropionic acid was substituted in place of the 2-chloropropionic acid.

Preparation of Silver Chloroacetate:

To 400 g of a well-mixed solution at 20° C. containing 60.6 g of sodium chloroacetate (0.52 mole) were rapidly added 167.9 g (0.50 mole) of a 5.0M AgNO₃ solution. The resulting suspension was stirred an additional 5 minutes at 20° C. The mixture was centrifuged and the solid phase was shaken with 500 ml of chilled water, centrifuged, and finally the solid phase was freeze-dried to a white free-flowing powder.

Preparation of Silver Trichloroacetate:

To a well-mixed solution at 20° C. of 20 g of water and 16.34 g of trichloroacetic acid (0.10 mole) was added a solution of 50 weight % NaOH (8.08 g) and then a 1M NaOH (0.04 g) solution to adjust the pH to 8.1. Then 33.58 g of a 5M AgNO₃ solution (0.10 mole) were added. The resulting mixture had a pH of 6.11. The mixture was centrifuged and the solid portion was freeze-dried without further washing due to the relatively high water solubility of this silver salt. A white free-flowing powder resulted.

Preparation of di-silver Tetrachloropbthalate:

To a well-mixed solution at 40° C. containing 234 g of water, 10.18 g (33 mmole) of tetrachlorophthalic acid, and 66.93 g of 1M NaOH (solution pH was 9.69) were added, at 7 ml/min, 76.2 g (0.067 mole) of a 1M AgNO₃ solution. The resulting mixture was centrifuged, washed 4 times adding 400 ml water between washes and finally the solid phase was freeze-dried to a white free-flowing powder.

Preparation of Sodium Hexanoate:

This salt was prepared similarly to that of sodium 2-chloropropionate except using 0.075 mole of hexanoic acid.

Preparation of Sodium 6-bromohexanoate:

This salt was prepared similarly to that of sodium 2-chloropropionate except using 0.075 mole of 6-bromohexanoate acid.

Preparation of Sodium 2-bromohexanoate:

This salt was prepared similarly to that of sodium 2-chloropropionate except using 0.075 mole of 2-bromohexanoate acid.

Preparation of Silver 2-bromohexadecanoate:

To a mixture of 350 g of water, and 52 g a 1M NaOH solution (0.05 mol) were added at 20° C., 16.8 g of 2-bromohexadecanoic acid (50 mmole) and then the mixture was heated to 52° C. to dissolve the carboxylic acid. The solution was cooled to 40° C. and had a pH of 8.6. With good stirring, 56.89 g of a 1.0M AgNO₃ solution (50 mmole) were added at 10 ml/min. The resulting mixture had a pH of 3.0 and a vAg of 425 mV (Ag/AgCl electrode). The mixture was centrifuged and washed 4 times by adding 600 ml of water between washes. The resulting paste was freeze-dried to yield a white free-flowing powder.

Preparation of Silver 2-bromohexanoate:

To a mixture of 14.4 g of water, and 10.5 g of 2-bromohexanoic acid (53.8 mmole) at 20° C. was added a 5M NaOH solution to adjust the pH to 7.0. To the resulting solution and with good stirring were rapidly added 61.2 g of a 1.0M AgNO₃ solution (53.8 mmole) and the resulting mixture was stirred at 20° C. for 10 minutes. The mixture had a pH of 3.4 and a vAg of 506 mV (Ag/AgCl electrode). The mixture was centrifuged and washed 2 times adding 200 ml of water between washes, and then centrifuged and washed with 200 ml of acetone. The resulting paste was vacuum-dried and packaged under nitrogen and yellow safe lights to yield a white free-flowing powder. After 24 hours in the dark at 20° C., the product turned to a dark brown gummy mass.

Preparation of Silver 6-bromohexanoate:

To a mixture of 14.4 g of water, and 10.5 g of 6-bromohexanoic acid (53.8 mmole) at 20° C. was added a 5.0M NaOH solution to adjust the pH to 7.0. To the resulting solution and with good stirring were rapidly added 61.2 g of a 1.0M AgNO₃ solution (53.8 mmole) and the resulting mixture was stirred at 20° C. for 10 minutes. The mixture had a pH of 3.8 and a vAg of 512 mV (Ag/AgCl electrode). The mixture was centrifuged and washed 2 times adding 200 ml water between washes, and then centrifuged and washed with 200 ml of acetone. The resulting paste was vacuum-dried and packaged under nitrogen and yellow safe lights to yield a white free-flowing powder. After 24 hours in the dark at ˜20° C., the product remained white.

Preparation of Silver 2-iodohippurate:

To a mixture of 350 g of water, and 26 g a 1M NaOH solution (0.025 mol) were added, at 20° C., 7.63 g of 2-iodohippuric acid (25 mmole). With good stirring, 28.4 g of a 1.0M AgNO₃ solution (25 mmole) were added at 20 ml/min. The resulting mixture had a pH of 8.34 and a vAg of 495 mV (Ag/AgCl electrode). The mixture was centrifuged and washed 3 times adding 200 ml of water between washes. The resulting paste was freeze-dried to yield a light tan free-flowing powder.

Differential Scanning Calorimetry (DSC) analysis data for most of these silver salts are given in TABLE I below.

Evidence that Selective Organic Halide Compounds Generate Silver Halide when Heated in the Presence of a Silver Source:

Differential scanning calorimetric analysis was performed on samples of silver- and halogen-containing compounds, and equal molar and ground together mixtures of a non-silver-containing halogen-containing organic compound and silver behenate. The sample was heated in an atmosphere of nitrogen at 10° C./min. to 200° C. or to 125° C., cooled, and then reheated to 200° C. For example, silver 2-chlorostearate on the first heating to 125° C. showed two small overlapping endothermic peaks at 50 and 54° C. (3.53 J/g), attributed to melting of free acid, and a much larger exothermic peak onset at 111.6° C., centered at 117.9° C., (+67.5 J/g), attributed to chlorostearate decomposition and formation of silver chloride. The reheating of the sample showed only one large and low temperature endothermic peak (liberates heat) at 40.7° C. (46.2 J/g), attributed to the melting of the chlorostearate decomposition products. No higher temperature peaks were observed on the second heating up to the maximum temperature examined (200° C.). The silver chlorostearate had completely decomposed during the first heating. All of the silver salts of the chloro-organic acids showed a major exothermic peak on the first heating that was absent upon the second heating (see TABLE I). Note that the first DSC peak (at ˜129° C.) observed for silver behenate (and other long chain silver soaps) is endothermic (absorbs heat) has been attributed to the structural transformation associated mainly with the disordering of the alkyl chains [S. Lee et. al., J. Phys. Chem. B, Vol. 106, pp. 2892-2900, (2002)]. Its cause is different than the exothermic peaks observed for the silver chloro-organic carboxylates presented in TABLE I. Note that the silver salts of non-halogen-substituted aliphatic carboxylic acids do not have a measurable exothermic peak at temperatures less than 200° C.

For the silver salts useful in the present invention, their temperature for formation of silver chloride is lower than otherwise development temperature of a silver behenate thermographic system. However the reaction temperature for the generation of silver chloride from silver chloroacetate (not a silver salt of this invention) is too high to be beneficial in reducing the development temperature.

TABLE I

| | First Exothermic | |
|---|---|---|
| | Peak between | Heat Liberated |
| | 20 and 200° C. | (+ is |
| | [Onset, | Exothermic) |
| Silver Compound | Max (° C.)] | (J/g) |
| Silver Behenate (acid free) | None, (124, 129) | −67 |
| Silver Behenate (˜9 mol % free acid) | None, (122, 127) | −64 |
| 2-Chlorostearic Acid | None, (62, 68) | −217 |
| Silver 2-chlorostearate | 112, 118 | +67.5 |
| Silver 2-chloropropionate | 106, 121 | +222 |
| Silver 3-chloropropionate | 137, 145 | +201 |
| Silver chloroacetate | 143, 153 | +265 |
| Silver trichloroacetate | 64, 84 | +192 |
| Di-silver 1,2-dichlorosuccinate | 162, 189 | +^{a} |
| Di-silver tetrachlorophthalate | None | — |
| 1:1 Mixture of 2-chloroacetophenone | 140, 158 | +74 |
| & silver behenate | | |
| 1:1 Mixture of 2- | 144, 160 | +75 |
| chloroproprionamide & silver | | |
| behenate | | |
| Silver 2-bromohexadecanoate | 63, 74 | +72 |
| Silver 2-bromohexanoate | 38, 60 | +119 |
| Silver 6-bromohexanoate | 65, 86 | +214 |
| 1:1 Mixture of 2-bromododecane & | 126, 127 | +1^{b} |
| silver behenate | | |
| Silver 2-iodohippurate | 138^{c} | +^{c} |
| 1:1 Mixture of 1-iodohexadecane & | 96, 109 | +5 |
| silver behenate | | |
| 1:1 Mixture of (2-iodoethyl)benzene | 94, 109 | +13 |
| & silver behenate | | |
| 1:1 Mixture of “TBrMSQ” & silver | 173, 178 | +79 |
| behenate | | |
| 1:1 Mixture of “monobromo” & | 164, 168 | +168 |
| Silver behenate | | |
| 1:1 Mixture of “dibromo” & silver | 166, 185 | +^{a} |
| behenate | | |

^{a}Heat liberated could not calculated because peak extended beyond cutoff temperature of 200° C.
^{b}Heat liberated appears smaller than it probably is because the exothermic peak is between two large and close silver behenate endothermic peaks.
^{c}Very broad and multiple peaks.

An aqueous thermal analysis test was developed to observe changes in silver ion concentration as a suspension of a silver soap was heated up to temperatures exceeding the boiling point of water. The silver soap (4.5 mmole) was suspended in 100 ml of a solution consisting of 25 wt % water and 75 wt % ethylene glycol. An Ag/AgCl reference electrode was used at room temperature by placing it within a salt bridge consisting of a solution of 75 wt % ethylene glycol and 25 wt % of an aqueous solution of 2.2M KNO₃ and 0.39M NaNO₃. The salt bridge was terminated with two fine porosity glass frits connected in series about 7 cm apart to prevent thermal currents from traveling up into the salt-bridge reservoir. A silver billet was used as the measuring electrode. With good mechanical stirring the suspension was heated in an oil bath from 40° C. to 125° C. requiring about 40 minutes. The measured vAg values were converted to silver ion concentrations and plotted against temperature. This heating process was repeated twice on the same suspension to look for permanent thermal changes in the sample.

A silver behenate control sample gave a silver ion concentration of 0.092 μM/l at 40° C., and continually increased reaching 396 μM/l at 125° C. The 2^{nd} heating resulted in a similar, but displaced, curve reaching 753 μM/1 at 125° C.

A silver 2-chlorostearate sample gave a silver ion concentration of 0.59 μM/l at 40° C., (pH of 3.89), and continually rose reaching a peak at 115° C. of 765 μM/l, then rapidly dropped while heating to a maximum temperature of 125° C. (363 μM/1) and subsequent cooling, 94 μM/l at 115° C. The 2^{nd} heating resulted in a relatively flat curve reaching a maximum silver ion concentration of only 3 μM/l at 125° C. (the pH at the end of the experiment was 2.08.). These results show that at 115-125° C. the 2-chloro group was released, consuming the silver ions (producing silver chloride) and significantly lowering of the silver ion concentration.

X-Ray Powder Diffraction Analysis:

A silver 2-chlorostearate powder sample was analyzed by XRD showing a repeating series of low angle diffraction peaks, resulting from a long-period spacing, with d₀₀₁ spacing of 37.26 Angstroms, and no silver chloride was detected. The powder sample was then placed on a platinum heating strip, part of a high temperature diffraction stage. An enclosure was placed over the stage and dry N₂ gas was used to purge the enclosure. The sample was heated to 125° C. at a rate of 20° C./min, held at 125° C. for 1 minute, and then cooled to room temperature at a rate of 50° C./min. The XRD results for the post-heated sample showed that the original phase was no longer present and that silver chloride has been generated due to thermal processing. Based on the peak width (0.65 degrees) of the (200) silver chloride peak the crystallite size was calculated to be 127 Angstroms. There was also an additional unidentified peak observed at 21.5 degrees 2-theta. It is probably due to an organic component that was generated during sample heating. None of the original peaks were observed.

GC Mass Spec, NMR, IR Analysis:

A silver 2-chlorostearate powder sample was sealed under nitrogen and heated at 125° C. overnight. Portions of the heated sample were derivatized to make methyl esters and trimethylsilyl ethers/esters for chromatography. The GC injection port temperature was programmed to follow the GC oven temperature to avoid high temperature decomposition. All spectra (MS, IR, NMR) were consistent with the following organic product structure.

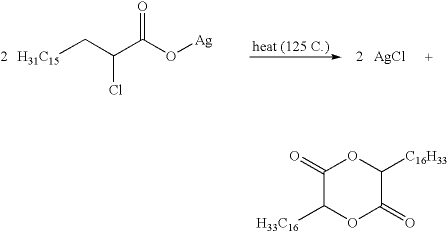

### COMPARATIVE EXAMPLE 1

In a 30 ml beaker were added 987 mg (2.0 mmole) of silver behenate, 0.20 g of BUTVAR® B79 polyvinyl butyral resin (Solutia, Inc.), and 17 g of methyl ethyl ketone (MEK). The beaker was placed in an ice-water bath and sonicated for 3 minutes using a Sonifier® Cell Disruptor 350 (Branson Sonic Power Co.) equipped with a 0.75 inch (1.9 cm) probe tip and set on 50% duty cycle and 5.5 power output (the ice-water bath maintained the mixture at temperatures near 20° C. during sonication). Then, 0.16 g of phthalazinone and 0.285 g of 2,3-dihydroxybenzoic acid were added and the mixture was sonicated as before but for 1 minute at a 3.0 power output. Then 2.0 g of BUTVAR® B-79 polyvinyl butyral resin was added to the mixture at room temperature and it was stirred for about 5 minutes. The mixture was filtered through a fine mesh screen and hand coated using a knife having a 0.23 mm gap onto clear poly(ethylene terephthalate) support having a thickness of 0.178 mm and warmed to 43° C. to prepare a direct thermographic material.

Silver analysis of the dried coating indicated the final component coverage was 1.26 g silver/m² (5.73 g of silver behenate/m²), 0.93 g/m² of phthalazinone, 1.66 g/m² of 2,3-dihydroxybenzoic acid, and 12.8 g/m² BUTVAR® B79 polyvinyl butyral resin.

### INVENTION EXAMPLES 1-5

These examples were prepared similarly to that of Comparative Example 1 except that an amount of silver 2-chlorostearate was substituted in place of an equal molar amount of the silver behenate. The total amount of silver added remained unchanged. The molar ratio of silver from the silver 2-chlorostearate is shown in TABLE II below.

### COMPARATIVE EXAMPLE 2

This example was prepared similarly to that of Comparative Example 1 except that 60 mol % of silver 2-chlorostearate was substituted in place of 60 mol % of the silver behenate. The total amount of silver added remained unchanged (see TABLE II).

### COMPARATIVE EXAMPLE 3

This comparative example was prepared similarly to Comparative Example 1 except that 940 mg (2.0 mmole) of silver 2-chlorostearate was added instead of the silver behenate (see TABLE II).

Coating Processing and Data:

The individual coatings were cut into small strips for a determination of the development-density produced at various process temperatures (20° C. and 100 to 170° C. in 5° C. increment) for development times of 5, 10, 15, and 20 seconds. The strips were immersed in silicone oil at the desired temperature for the desired time. They were then rinsed in hexane and the resulting density was read using a combination of Status A filters as a visual density using a Macbeth TD504 densitometer and the appropriate filters (see T. H. James, The Theory of the Photographic Process, 4^{th} Ed., Macmillan Publishing Co., Inc., N.Y., 1977, page 521 for details of this process). The densities vs. temperature plots were constructed for each of the four development times. The data are summarized in TABLE II. Also provided in TABLE II are the temperatures required to reach a density of 2.0 for the homogeneous silver soaps (note that all densities were greater than 3.0 at 170° C.), and the number of degree units that a curve needed to be shifted to best overlay it on top of the reference curve (that is, 100% silver behenate). A negative valve means that the measuring curve occurred at a lower temperature than the reference curve.

The samples were also examined for printout, TABLE IV. The fresh non-processed coating density was compared to that obtained after being exposed for 24 hours to fluorescent lighting (about 65 foot-candles or 699 lux) while in an environment of 77% relative humidity and 21° C.

TABLE II

| | | Temperature to | Displacement of |
|---|---|---|---|
| | Ag Chlorostearate | Obtain Density of 2.0 | Density Curve |
| | (mole | for 5, 10, 15, 20 | for 5, 10, 15, 20 |
| Thermographic Coating | % of Ag) | seconds (° C.) | seconds (° C.) |
| Comparative Example 1 | 0% | 145, 140, 138.5, 138 | 0, 0, 0, 0 |
| | | | (Control) |
| Invention Example 1 | 1% | | −1, −1.5, −1, −2 |
| Invention Example 2 | 5% | | −5.5, −6, −6.5, −7.5 |
| Invention Example 3 | 10% | | −9, −9, −10.5, −11 |
| Invention Example 4 | 20% | | −9, −10, −11, −11 |
| Invention Example 5 | 40% | | −8, −9, −9, −11 |
| Comparative Example 2 | 60% | | +5, +4, +4, +3 |
| Comparative Example 3 | 100% | 152, 149, 147, 148 | +7, +9, +8.5, +10 |

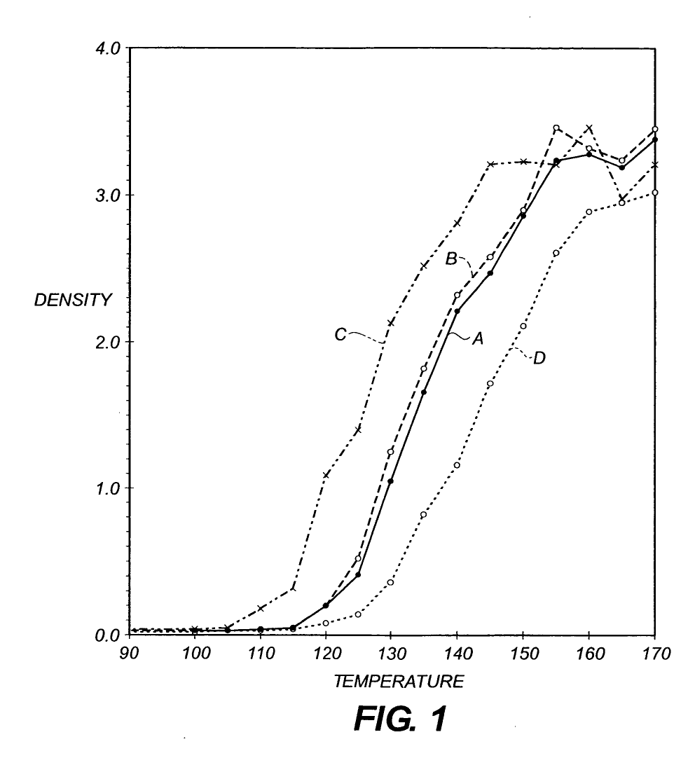

As can be seen from the data in TABLE II and FIG. 1, thermographic coating samples containing mixtures of the silver 2-chlorostearate and silver behenate (Invention Examples 1-5) consistently gave developed density at lower temperatures than did the coating samples of Comparative Examples 1-3. The relatively lower temperature needed for the generation of silver chloride from the silver 2-chlorostearate produced silver chloride that catalyzed the development of silver behenate at a lower temperature.

In FIG. 1, Curves A, B, C, and D represent the data for Comparative Example 1, Invention Example 1, Invention Example 3, and Comparative Example 3, respectively.

### COMPARATIVE EXAMPLE 4

This comparative example was prepared similarly to Comparative Example 1 except that 715 mg (2.0 mmole) of silver myristate was added instead of silver behenate (see TABLE III below).

### INVENTION EXAMPLE 6

This example was prepared similarly to that of Comparative Example 4 except that 94 mg (10 mol %) of silver 2-chlorostearate was substituted in place of an equal molar amount of silver myristate. The total amount of silver added remained unchanged (see TABLE III).

### COMPARATIVE EXAMPLE 5

This comparative example was prepared similarly to Comparative Example 1 except that 474 mg (1.0 mmole as compound, 2.0 mmole as silver) of silver 1,12-dodecanedicarboxylate was added instead of silver behenate (see TABLE III).

### INVENTION EXAMPLE 7

This example was prepared similarly to that of Comparative Example 5 except that 94 mg (10 mol % of silver) of silver 2-chlorostearate was substituted in place of an equal molar amount of the silver from silver 1,12-dodecanedicarboxylate. The total amount of silver added remained unchanged (see TABLE III).

TABLE III

| | | Ag | Temperature to Obtain | Displacement of Density |
|---|---|---|---|---|
| Thermographic | | Chlorostearate | Density of 2.0 for 5, 10, 15, | Curve for 5, 10, 15, 20 |
| Coating | Major Ag Soap | (mole % of Ag) | 20 seconds (° C.) | seconds (° C.) |
| Comparative | Myristate | 0% | 144.5, 139, 138, 136 | |
| Example 4 | | | | |
| Invention Example 6 | Myristate | 10% | | −4, −4, −4, −4 |
| Comparative | 1,12-Dodecane- | 0% | 156, 151, 151, 148.5 | |
| Example 5 | dicarboxylate | | | |
| Invention Example 7 | 1,12-Dodecane- | 10% | | −8, −7.5, −8.5, −8.5 |
| | dicarboxylate | | | |

As can be seen from the data in TABLE III, thermographic coatings containing mixtures of the silver 2-chlorostearate and another organic silver salt (Invention Examples 6 and 7) gave developed density at lower temperatures compared to the coating containing the corresponding single organic silver salt (Comparative Examples 4 and 5). Note that a myristic acid molecule has a carbon chain of 14 carbon atoms compared to behenic acid having 22 carbon atoms so the former would have a lower melting point and the silver salt would be expected to have greater solubility but the temperatures to obtain a density of 2.0 at each development time for Comparative Example 1, made with silver behenate, was nearly the same as Comparative Example 4 made with silver myristate (see TABLES II and III).

### INVENTION EXAMPLE 8

This example was prepared similarly to that of Comparative Example 1 except that 10 mol % of silver 2-chloropropionate was substituted in place of 10 mol % of the silver behenate. The total amount of silver added remained unchanged (see TABLE IV below for the results).

### INVENTION EXAMPLE 9

This example was prepared similarly to that of Comparative Example 1 except that 10 mol % of 2-chloropropionic acid was added just after the MEK. The total amount of silver added remained unchanged (see TABLE IV).

### INVENTION EXAMPLE 10

This example was prepared similarly to that of Comparative Example 1 except that 10 mol % of sodium 2-chloropropionate was added before the MEK. The total amount of silver added remained unchanged (see TABLE IV).

### INVENTION EXAMPLE 11

This example was prepared similarly to that of Invention Example 8 except that silver 3-chloropropionate was substituted for the silver 2-chloropropionate. The total amount of silver added remained unchanged (see TABLE IV).

### COMPARATIVE EXAMPLE 6

This example was prepared similarly to that of Invention Example 8 except that silver chloroacetate was substituted for the silver 2-chloropropionate. The total amount of silver added remained unchanged (see TABLE IV).

### INVENTION EXAMPLE 12

This example was prepared similarly to that of Comparative Example 1 except that 16 g of MEK was used instead of 17 g and 1 g of a solution consisting of 327 mg of trichloroacetic acid and 9.67 g of MEK was added just before the 2^{nd} sonication (see TABLE IV).

### COMPARATIVE EXAMPLE 7

This example was prepared similarly to that of Invention Example 8 except that 10 mol % silver as di-silver 2,3-dichlorosuccinate was substituted for the silver 2-chloropropionate. The total amount of silver added remained unchanged (see TABLE IV).

### INVENTION EXAMPLE 13

This example was prepared similarly to that of Comparative Example 1 except that 10 mol % of 2-chloroacetophnone was added just after the MEK. The total amount of silver added remained unchanged (see TABLE IV).

### COMPARATIVE EXAMPLE 8

This example was prepared similarly to that of Comparative Example 1 except that 10 mol % of 2-chloroproprionamide was added just after the MEK. The total amount of silver added remained unchanged (see TABLE IV).

### INVENTION EXAMPLE 14

This example was prepared similarly to that of Comparative Example 1 except that 10 mol % of silver 2-bromohexadecanoate was substituted in place of 10 mol % of the silver behenate. The total amount of silver added remained unchanged (see TABLE IV).

### INVENTION EXAMPLE 15

This example was prepared similarly to that of Comparative Example 1 except that 10 mol % of sodium 6-bromohexanoate was added before the MEK. The total amount of silver added remained unchanged (see TABLE IV).

### COMPARATIVE EXAMPLE 9

This example was prepared similarly to that of Comparative Example 1 except that 10 mol % of sodium 2-bromohexanoate was added before the MEK. The total amount of silver added remained unchanged (see TABLE IV).

### COMPARATIVE EXAMPLE 10

This example was prepared similarly to that of Comparative Example 1 except that 10 mol % of sodium hexanoate was added before the MEK. The total amount of silver added remained unchanged (see TABLE IV).

### COMPARATIVE EXAMPLE 11

This example was prepared similarly to that of Comparative Example 1 except that 10 mol % of hexanoic acid was added before the MEK. The total amount of silver added remained unchanged (see TABLE IV).

### INVENTION EXAMPLE 16

This example was prepared similarly to that of Comparative Example 1 except that 10 mol % of 2-bromododecane was added before the MEK.

The total amount of silver added remained unchanged (see TABLE IV).

### INVENTION EXAMPLE 17

This example was prepared similarly to that of Comparative Example 1 except that 10 mol % of 1-iodohexadecane was added before the MEK.

The total amount of silver added remained unchanged (see TABLE IV).

### INVENTION EXAMPLE 18

This example was prepared similarly to that of Comparative Example 1 except that 10 mol % of (2-iodoethyl)benzene was added before the MEK. The total amount of silver added remained unchanged (see TABLE IV).

### INVENTION EXAMPLE 19

This example was prepared similarly to that of Comparative Example 1 except that 10 mol % of silver 2-iodohippurate was added before the MEK. The total amount of silver added remained unchanged (see TABLE IV).

### COMPARATIVE EXAMPLE 12

This example was prepared similarly to that of Comparative Example 1 except that 89 mg of “TBrMSQ” (10 mol %) were added just after the addition of 2,3-dihydroxybenzoic acid (see TABLE IV).

### COMPARATIVE EXAMPLE 13

This example was prepared similarly to that of Comparative Example 1 except that 58 mg of “monobromo” (10 mol %) were added just after the addition of 2,3-dihydroxybenzoic acid (see TABLE IV).

### COMPARATIVE EXAMPLE 14

This example was prepared similarly to that of Comparative Example 1 except that 52 mg of “dibromo” (5 mol %) were added just after the addition of 2,3-dihydroxybenzoic acid (see TABLE IV).

### COMPARATIVE EXAMPLE 15

This example was prepared similarly to that of Invention Example 8 except that 10 mol % silver as di-silver tetrachlorophthalate was substituted for the silver 2-chloropropionate. The total amount of silver added remained unchanged (see TABLE IV).

TABLE IV

| | Halogen-Containing | Displacement of Density | |
|---|---|---|---|
| | Compound Added to Ag | Curve for 5, 10, 15, 20 | Print-out Density |
| Thermographic Coating | Behenate | seconds (° C.) | Increase^{b} |
| Comparative Example 1 | None | 0, 0, 0, 0^{a} | 0.00 |
| | | (Control) | |
| Invention Example 3 | Silver | −9, −9, −10.5, −11 | 0.02 |
| | 2-Chlorostearate | | |
| Invention Example 8 | Silver | −8, −6, −5, −5 | 0.03 |
| | 2-Chloropropionate | | |
| Invention Example 9 | 2-Chloropropionic acid | −9, −9, −9, −8 | 0.01 |
| Invention Example 10 | Sodium | −13, −12.5, −12, −11 | 0.00 |
| | 2-Chloropropionate | | |
| Invention Example 11 | Silver | −4, −2, 0, 0 | 0.01 |
| | 3-Chloropropionate | | |
| Comparative Example 6 | Silver | −1, 0, 0, 0 | 0.01 |
| | Chloroacetate | | |
| Invention Example 12 | Trichloroacetic Acid | −10, −11, −10, −7 | 0.03 |
| Comparative Example 7 | Di-silver | +1, 0, +2, +2 | 0.11 |
| | 2,3-Dichlorosuccinate | | |
| Invention Example 13 | 2-Chloroacetophenone | −3, −3, −1, −3 | 0.00 |
| Comparative Example 8 | 2-Chloroproprionamide | 0, 0, 0, 0 | 0.00 |
| Invention Example 14 | Silver 2- | −9, −9, −10, −8 | 0.03 |
| | Bromohexadecanoate | | |
| Invention Example 15 | Sodium 6- | −16, −14, −13, −14 | 0.01 |
| | Bromohexanoate | | |
| Comparative Example 9 | Sodium 2- | −7, −6, −5, −4 | 0.04 |
| | Bromohexanoate | | |
| Comparative Example 10 | Sodium hexanoate | −2, −1, −2, −2 | 0.01 |
| Comparative Example 11 | Hexanoic Acid | −2, −1, −2, −2 | 0.01 |
| Invention Example 16 | 2-Bromododecane | −6, −5, −8, −7 | 0.00 |
| Invention Example 17 | 1-Iodohexadecane | −11, −9, −12, −13 | 0.01 |
| Invention Example 18 | (2-Iodoethyl)benzene | −12, −8, −11,−11 | 0.01 |
| Invention Example 19 | Silver | −7, −8, −7, −10 | 0.02 |
| | 2-Iodohippurate | | |
| Comparative Example 12 | “TBrMSQ” | +7, +9, +8, +9 | 0.00 |
| Comparative Example 13 | “Monobromo” | −3, −1, 0, 0 | 0.00 |
| Comparative Example 14 | “Dibromo” | +13, +17, +17, +19 | 0.00 |
| Comparative Example 15 | Di-silver | 0, +2, +3, +4 | 0.01 |
| | Tetrachlorophthalate | | |
| Invention Example 20 | Sodium 2-bromo- | −13, −14, 12, 13 | 0.01 |
| | hexadeacanoate & (2- | | |
| | Iodoethyl)benzene | | |

^{a}Temperatures to obtain a density of 2.0 for 5, 10, 15, and 20 seconds were 147, 141, 139, and 137° C.
^{b}For all samples fresh Dₘᵢₙ was 0.05 or less.

The results in TABLES I and IV show that the halogen-containing compounds that are effective in reducing the development temperature are those that, in the presence of a silver source have an exothermic DSC peak in the temperature range of 60 to 141° C. (attributable to release of the halogen and formation of silver halide, that is, Invention Examples 3, 8-12, and 14-19). Halogen-containing compounds having the exothermic DSC peak onset below 60° C. are too thermally unstable generating silver halide during storage at room temperature. 2-Bromohexanic acid and its salts are an example of this a too low thermal stability (see Comparative Example 9). The DSC data showed that silver 2-bromohexanoate gave an exothermic peak with an onset of only 38° C., and the silver salt preparation above described its decomposition in only 24 hours of dark storage. Comparative Example 9, made using sodium 2-bromohexanoate, showed one of the two highest print-out density increases of TABLE IV, this and the along with development temperature lowering consistent with silver bromide, not the halogen-containing compounds, being in the coating prior to the printout test.

Silver 2,3-dichlorosuccinate showed only a high temperature exothermic DSC peak (onset at 144° C., TABLE I) consistent with its poor performance as a development temperature-lowering compound (Comparative Example 7, TABLE IV). The high printout of this coating at 77% RH (Print-out Density=0.11, TABLE IV) and the much lower printout found at ˜40% RH for 24 hours (Print-out Density=0.03) shows that the high printout was due to generation of silver chloride in the coating by hydrolysis of this chloro-containing compound during the high humidity printout test. The higher than expected printout of Invention Example 8 suggests that some silver chloride was generated by hydrolysis prior to making the coating melt, and shows an advantage in adding some of the less stable silver salts as the free acid or the alkali metal salt i.e., compare the printout of Invention Examples 8-10 in TABLE IV. Note that Comparative Example I of TABLE IV is a repeat experiment of that used in TABLE II and required similar temperatures to obtain density of 2.0. From multiple repeat experiments, the estimated experimental error is within 2° C. All displacement of the density curve values were measured against a silver behenate control coating in the same coating set.

### COMPARATIVE EXAMPLE 16

This example was prepared similarly to that of Comparative Example 1 except that the silver behenate used was prepared in the following manner.

To 400 g of water containing 38.4 g of 1M NaOH (37 mmole) were added 12.98 g of behenic acid (38.1 mmole). The mixture was heated to 90° C. to dissolve the acid. At 80° C. and with good stirring was added, at 3 ml/min, 42.1 g of 1M AgNO₃ (37 mmole). The resulting mixture was held at 80° C. for 10 minutes and then cooled to 40° C. It was divided into two equal parts. One part was centrifuged and washed 6 times using 500 ml of water for each wash and then the resulting past was freeze-dried to a white free-flowing powder. The other unwashed part was used to prepare Comparative Example 17. See TABLE V below for the results.

### COMPARATIVE EXAMPLE 17

This example was prepared similarly to that of Comparative Example 1 except that the silver behenate used was treated with 10 mol % of sodium bromide. It was prepared in the following manner.

To the other unwashed Ag behenate portion described in Comparative Example 16 was added, with good mixing, 18.6 g of a 0.10M sodium bromide solution (1.85 mmol) at 1.0 ml/min and then the mixture was held for 10 minutes. It was washed and freeze-dried to yield a white free-flowing powder. A portion of the freeze-dried powder was analyzed for halide by neutron activation analysis and found to contain 2.3 wt % bromide. See TABLE V for the results.

### COMPARATIVE EXAMPLE 18

This example was prepared similarly to that of Comparative Example 1 except that the silver behenate used was prepared in the following manner.

To 400 g of water containing 38.4 g of 1M NaOH (37 mmole) was added 12.98 g of behenic acid (38.1 mmole). The mixture was heated to 90° C. to dissolve the acid. At 80° C. and with good stirring were added 46.3 g of a 1M AgNO₃ solution (37 mmole) at 3 ml/min and 38.0 g of a 0.1M sodium bromide solution (3.7 mmole) at 3 ml/min. The resulting mixture was held at 80° C. for 10 minutes and then cooled to 40° C. The suspension was centrifuged and washed 6 times using 1 liter of water for each wash, and then the resulting past was freeze-dried to a white free-flowing powder. A portion of the freeze-dried powder was analyzed for halide by neutron activation analysis and found to contain 1.9 weight % bromide. See TABLE V for the results.

TABLE V

| | Silver Halide | Displacement | Print-out |
|---|---|---|---|
| | Present during | of Density | Density |
| Thermographic | Silver Behenate | Curve for 5, 10, 15, 20 | Increase |
| Coating | Preparation | seconds (° C.) | (fresh Dₘᵢₙ) |
| Comparative | None | 0, 0, 0, 0 | 0.00 (0.04) |
| Example 16 | (<0.02 weight %) | (control) | |
| Comparative | Sodium Bromide | −7, −9, −8, −7 | 0.05 (0.10) |
| Example 17 | (2.3 weight %) | | |
| Comparative | Silver Bromide | −4, −5, −4, −4 | 0.07 (0.10) |
| Example 18 | (1.9 weight %) | | |

The results presented in TABLE V show that the presence of silver bromide (sodium bromide) in the coating can result in a favorable reduction in the process temperature but it also results in unacceptable printout and higher fresh Dₘᵢₙ (compare the print-out of Comparative Example 16 with that of Comparative Examples 17 and 18).

The invention has been described in detail with particular reference to certain preferred embodiments thereof, but it will be understood that variations and modifications can be effected within the spirit and scope of the invention.

1. A non-photosensitive direct thermographic material comprising a support having thereon at least one thermally sensitive imaging layer comprising a binder, and further comprising:
a) a non-photosensitive, non-halogen-containing organic silver salt that is incapable of forming silver halide in imaged areas when heated to a temperature between 60 and 141° C.,
b) a reducing agent for reducible silver ions in said organic silver salt, and
c) a halogen-containing organic compound that has at least 2 carbon atoms and is capable of releasing its halogen to form silver halide when heated to a temperature between 60 and 141° C. in the presence of a source of silver, the thermally releasable halogen being present in an amount of from about 1 to 49 mol % based on total silver in said material.

2. The material of claim 1 wherein the thermally releasable halogen is present in an amount of from about 2 to about 20 mol % based on total silver.

3. The material of claim 1 wherein said halogen-containing organic compound is a carboxylic acid or its salt having at least 2 carbon atoms and is capable of releasing its chlorine, bromine, or iodine to form silver chloride, silver bromide, or silver iodide, respectively, when heated to a temperature between 60 and 141° C. in the presence of a source of silver.

4. The material of claim 1 wherein said halogen-containing compound is a silver salt of a carboxylic acid.

5. The material of claim 4 wherein said non-photosensitive, non-halogen-containing organic silver salt is present at a concentration of from 51 to about 99 mol % based on total silver and said halogen-containing organic compound is a halogen-containing organic silver salt that is present at a concentration of from about 1 to 49 mol % based on total silver.

6. The material of claim 3 wherein said halogen-containing organic compound is a silver salt of an α-chlorocarboxylic acid is capable of releasing its chlorine to form silver chloride when heated to a temperature of between 80 and 140° C.

7. The material of claim 3 wherein said halogen-containing compound is a silver salt of an α-chlorocarboxylic acid represented by the following Structure (I):
R—CH(Cl)-COOAg (I)
wherein R is an aliphatic or cyclic group having a molecular weight of at least 15 and up to 600.

8. The material of claim 7 wherein R is an aliphatic group having at least 1 carbon atom.

9. The material of claim 1 wherein said halogen-containing compound is one or more of 2-chlorostearic acid, 2-chloropropionic acid, 2-bromohexadecanoic acid, 6-bromohexadecanoic acid, 2-bromododecane, 1-iodohexadecane, (2-iodoethyl)benzene, and 2-iodohippuric acid.

10. The material of claim 1 wherein said halogen-containing compound is a silver salt of one or more of 2-chlorostearic acid, 2-chloropropionic acid, 2-bromohexadecanoic acid, 6-bromohexadecanoic acid, 2-bromododecane, 1-iodohexadecane, (2-iodoethyl)benzene, and 2-iodohippuric acid

11 The material of claim 1 wherein said non-photosensitive, non-halogen-containing organic silver salt includes one or more silver aliphatic carboxylates including at least silver behenate.

12. The material of claim 11 wherein said one or more silver aliphatic carboxylates includes highly crystalline silver behenate.

13. The material of claim 1 wherein said halogen-containing compound has fewer carbon atoms than said non-photosensitive, non-halogen-containing organic silver salt.

14. The material of claim 1 comprising a total amount of silver of at least 0.002 mol/m².

15. The material of claim 1 further comprising a toning agent that is present in an amount of from about 0.01 to about 10% based on the total dry weight of the layer in which it is located.

16. The material of claim 1 that is duplitized, having one or more of the same or different imaging layers on both sides of said support.

17. The material of claim 1 comprising a halogen-containing organic compound that is a silver salt of a halogen-containing carboxylic acid, and a second halogen-containing organic compound that is not a silver salt.

18. A black-and-white, non-photosensitive thermographic material that comprises a transparent polymer support having on only one side thereof one or more thermally sensitive imaging layers and an outermost non-thermally sensitive protective layer over said one or more thermally sensitive imaging layers, said material comprising a total amount of silver of from about 0.002 to about 0.03 mol/m²,
said one or more thermally sensitive imaging layers comprising one or more binders, and in reactive association:
a) a non-photosensitive, non-halogen-containing silver carboxylate salt comprising silver behenate and from about 51 to 99 mol % of total silver in said material,
b) a reducing agent for said non-photosensitive source reducible silver ions comprising a dihydroxybenzene,
c) a toning agent, and
d) an organic silver salt of 2-chlorostearic acid, 2-chloropropionic acid, 2-bromohexadecanoic acid, 6-bromohexadecanoic acid, or 2-iodohippuric acid, and comprising from about 1 to 49 mol % of total silver in said material.

19. A black-and-white, non-photosensitive thermographic material that comprises a transparent polymer support having on only one side thereof one or more thermally sensitive imaging layers and an outermost non-thermally sensitive protective layer over said one or more thermally sensitive imaging layers, said material comprising a total amount of silver of from about 0.002 to about 0.03 mol/m²,
said one or more thermally sensitive imaging layers comprising one or more binders, and in reactive association:
a) a non-photosensitive, non-halogen-containing silver carboxylate salt comprising silver behenate and 100 mol % of total silver in said material,
b) a reducing agent for said non-photosensitive source reducible silver ions comprising a dihydroxybenzene,
c) a toning agent, and
d) 2-bromodecane, 1-iodohexadecane, or (2-iodoethyl)benzene that comprises thermally releasable halide in an amount of from about 1 to 49 mol % based on total silver in said material.

20. A method comprising imaging the thermographic material of claim 1 with a thermal imaging source to provide a visible image.

21. The method of claim 20 wherein said thermographic material comprises a transparent support and said image-forming method further comprises:
positioning said imaged thermographic material with the visible image thereon between a source of imaging radiation and an imageable material that is sensitive to said imaging radiation, and
thereafter exposing said imageable material to said imaging radiation through the visible image in said imaged thermographic material to provide an image in said imageable material.

22. The method of claim 20 wherein said imaging is carried out using a thermal print head or a laser.

23. The method of claim 20 further comprising using said imaged thermographic material for medical diagnostic purposes.

24. The method of claim 20 wherein said imaging is carried out using a thermal print head or a laser.

25. The method of claim 20 further comprising using said imaged thermographic material for medical diagnostic purposes.
